(19) United States
(12) Patent Application Publication
(10) Pub. No.: US 2013/0305724 A1
(43) Pub. Date: Nov. 21, 2013

(54) AUXILIARY POWER SYSTEM AND METHOD

(71) Applicant: DENNIS MICHAEL CUPP, Salem, OR (US)

(72) Inventor: DENNIS MICHAEL CUPP, Salem, OR (US)

(21) Appl. No.: 13/473,036

(22) Filed: May 16, 2012

(51) Int. Cl. F02D 25/00; F25B 27/00; F04B 17/05

(52) U.S. Cl. 60/711; 417/364; 62/236; 417/53; 62/56

(57) ABSTRACT

An auxiliary power system that is coupled a truck is described. The auxiliary power system pumps a fluid material housed by a truck hydraulic tank and bypasses the truck engine to affect a pump that offload the fluid material. The auxiliary power system includes a housing, an auxiliary engine, a pump, a suction line, a pressure line, and an offload control module. A method for configuring an auxiliary power system to bypass a truck engine is also described. The method includes controlling a pump that is operatively coupled to an auxiliary engine with an offload control module, in which the pump is powered by the auxiliary engine.

### FIELD OF THE INVENTION

The present invention relates to an auxiliary power system and method. More specifically, the invention relates to an auxiliary power system that pumps a fluid material and bypasses using the truck engine to perform the fluid material offload.

### BACKGROUND

The impact of a heavy-duty diesel engine idling in the trucking industry is known to be substantial. Firstly, the amount of fuel consumed during idling affects operational costs, i.e. increases expenses. Secondly, the environmental impact corresponding to high fuel consumption adversely affects air quality. Thirdly, operational costs are increased because of engine wear caused by idling engines, which requires engine replacement or engines being rebuilt. Fourthly, the maintenance of idling engines also increases the need for oil change and replacement of other fluids that are necessary for operating the diesel engine.

Diesel truck engines are left idling for various reasons such as for sleep car and truck heating, ventilation, and air conditioning (HVAC). Additionally, diesel truck engines are left to idle to maintain elevated temperatures of the diesel engine block in cold climates.

Diesel truck engines also include a power take-off (PTO) that takes power from an operating power source, such as a diesel truck engine, and can then be used to provide power to separate machines or attachments. The PTO may be embodied as a PTO shaft that can be easily connected or disconnected. Additionally, semi-permanently mounted PTO can be found on the diesel truck engine for unloading or “off-loading” materials such as propane or other such bulk liquids.

### SUMMARY

An auxiliary power system that is coupled a truck is described. The auxiliary power system pumps a fluid material housed by a truck hydraulic tank and bypasses the need to use the truck engine to perform the fluid material offload. In a first illustrative embodiment, the auxiliary power system includes a housing, an auxiliary engine, a pump, a suction line, a pressure line, and an offload control module. The housing is fixedly coupled to a truck frame. The auxiliary engine is operatively coupled to a truck fuel tank. The pump is also operatively coupled to the auxiliary engine and the pump is powered by the auxiliary engine. The suction line is coupled to the pump. Additionally, the suction line is coupled to a truck hydraulic tank and receives a material housed by the truck hydraulic tank. Furthermore, the pressure line is operatively coupled to the pump. The offload control module is electrically coupled to the auxiliary engine and the offload control module is configured to control the pump. In one illustrative embodiment, the housing includes an engine mount and the auxiliary engine is fixedly coupled to the engine mount.

In the illustrative embodiment, the pressure line may be configured to transfer the material from the truck hydraulic tank to a second hydraulic tank. Also, the auxiliary power system includes an offload pump that is operatively coupled to the pressure line and regulates flow of the hydraulic material transferred to the second hydraulic tank.

Additionally, the illustrative embodiment may include a sleeper control module that is electrically coupled to the auxiliary engine, and the sleeper control module controls the temperature corresponding to a truck sleeper cab. A cooling system may also include an air conditioning system pump operatively coupled to the auxiliary engine, in which the cooling system is controlled by the sleeper control module. Furthermore, the auxiliary engine may be operatively coupled to a fan and a radiator. The housing may include vents that enable air to flow to the fan and the radiator.

A method for configuring an auxiliary power system to bypass a truck engine is also described. The method includes controlling a pump that is operatively coupled to an auxiliary engine with an offload control module and the pump is powered by the auxiliary engine. The auxiliary engine is also coupled to a truck fuel tank. The auxiliary engine also includes a fan and a radiator. Air flows through a vented housing that is fixedly coupled to the truck. The vented housing receives the auxiliary engine, fan, and radiator. The material housed by the truck hydraulic tank is transferred via a suction line to the pump, to a pressure line that is also coupled to the pump. The suction line is coupled to the truck hydraulic tank. The pressure line transfers the material from the truck hydraulic tank to a second hydraulic tank.

The method may also include coupling the auxiliary engine to an engine mount that corresponds to the housing. Additionally, the method may regulate the flow of the hydraulic material transferred to the second hydraulic tank with an offload pump that is coupled to the pressure line. The method also controls the temperature corresponding to a truck sleeper cab with a sleeper control module that is electrically coupled to the auxiliary engine. For example, a cooling system that includes an air conditioning system pump operatively coupled to the auxiliary engine is controlled by the sleeper control module. Furthermore, the method may also enable the offload control module to control valves disposed between the truck hydraulic tank and an offload pump.

In the illustrative embodiment, the method enables the auxiliary engine to transfer the material housed by the truck hydraulic tank without engaging a truck engine.

### DRAWINGS

The present invention will be more fully understood by reference to the following drawings which are for illustrative, not limiting, purposes.

FIG. 1 shows a high level system drawing of an illustrative auxiliary power system.

FIG. 2 shows a system diagram that includes various control modules interfacing with the electrical systems corresponding to the auxiliary power systems of FIG. 1.

FIG. 3 shows an illustrative HVAC system corresponding to the auxiliary power system of FIG. 1.

FIG. 4 shows an illustrative hydraulic system that is used to replace an existing power takeoff system.

FIGS. 5A and 5B each present isometric side views of an engine mount assembly that is configured to interface with the auxiliary engine. FIG. 5C presents the L-brackets motor mounts that are joined to the auxiliary engine.

FIG. 6 presents an isometric view of an illustrative vented housing for the auxiliary engine.

FIG. 7A presents a method for configured the auxiliary power system to bypass the truck engine in order to transfer fluid from the truck hydraulic tank.

FIG. 7B presents a method where the auxiliary power system can also be used to bypass the truck engine to control temperature in the sleeper cab.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the apparatus and systems described herein may vary as to configuration and as to details. Additionally, the methods may vary as to details, order of the actions, or other variations without departing from the illustrative method disclosed herein.

The apparatus, systems, and methods described herein are described from the perspective of “offloading” or unloading propane. However, the apparatus, systems, and methods described herein can be applied more generally to bulk liquid transport such as petroleum and chemical products. More generally, the apparatus, systems, and methods described herein can also be applied to any bulk liquid that is transported using a truck engine.

By way of example and not of limitation, the illustrative apparatus, systems, and methods describe the offloading of propane more efficiently by using an auxiliary power unit (APU) than by idling diesel truck engine having a power takeoff (PTO) pump.

The auxiliary power system uses substantially less fuel than the truck diesel engine for offloading propane from the truck hydraulic tank. For example, to offload 10,000 gallons of propane, the diesel truck engine has a power takeoff that has to run at 1100 rpm and uses approximately 1.75 gallons per hour. The illustrative auxiliary power system described herein uses approximately 0.8 gallons per hour to offload 10,000 gallons of propane.

Additionally, the use of the auxiliary power system described can also be used to provide HVAC. Thus, the auxiliary power system described herein is a dual purpose unit that can enable bulk liquid offloading and can provide HVAC to the truck sleeper cab. Additionally, the auxiliary power system can be used as a back-up power source and can be used to warm the main diesel truck engine in cold climates.

As a result, the auxiliary power system increases the operating life of the main diesel truck engine, conserves fuel, and complies with emission laws.

In the illustrative embodiment described herein, the auxiliary power system is mounted on the frame rail of a truck. By way of example and not of limitation, the auxiliary power system includes an illustrative four-cylinder diesel engine that has a radiator. A direct drive and a hydraulic pump are configured to interface with customer tanks and customer controls. In the illustrative embodiment, the controls reside near the truck sleeper cab and are exterior to the sleeper cab. Additionally, an operator can perform the offload from additional controls inside the sleeper berth and control heating, air conditioning, and fan controls.

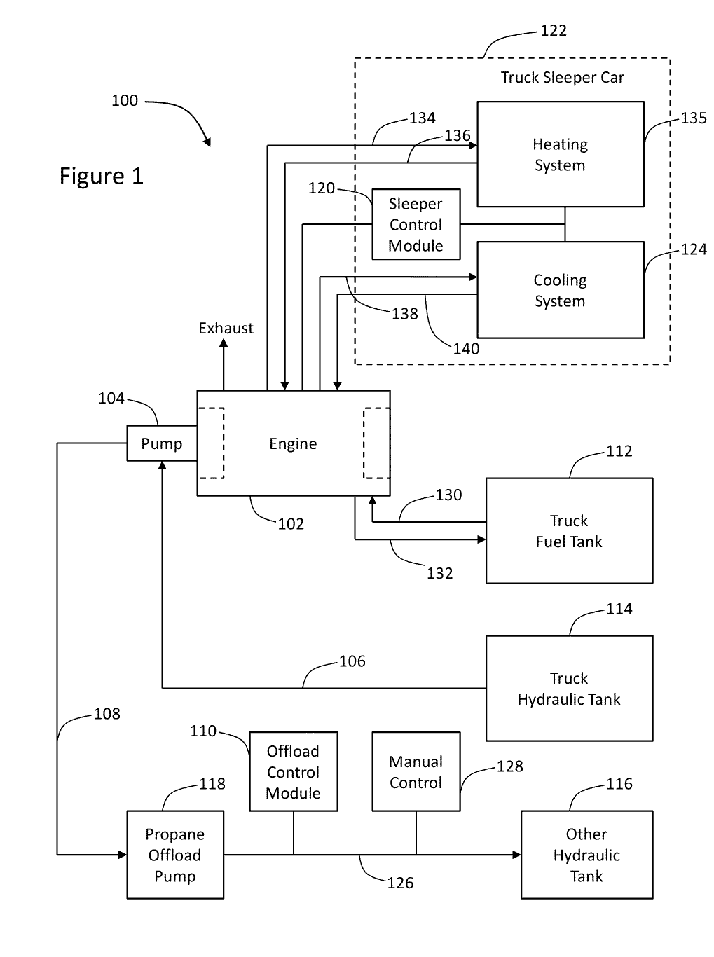

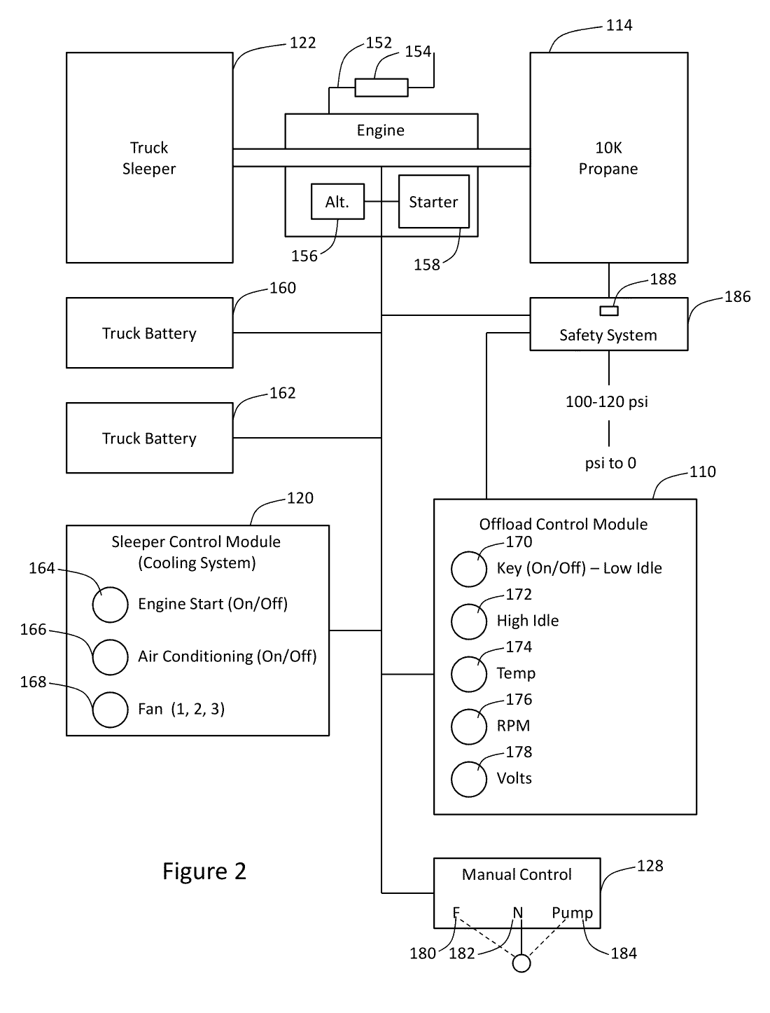

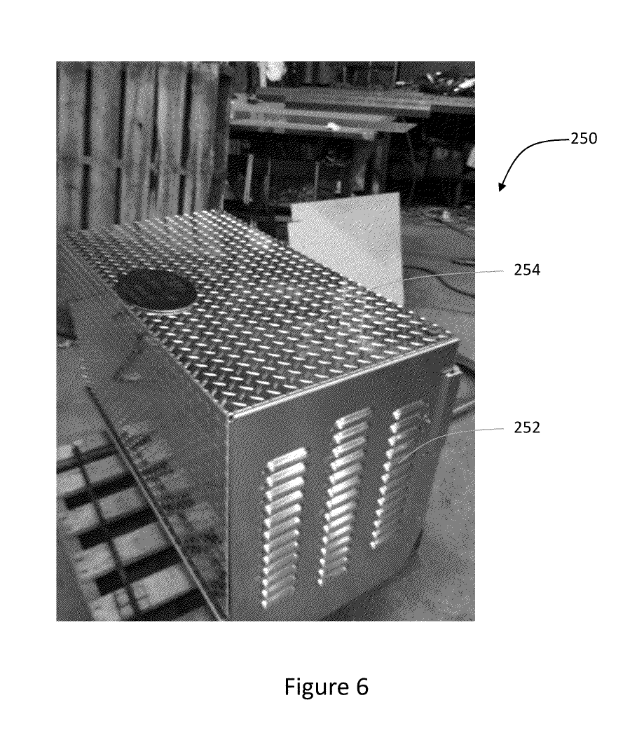

Referring to FIG. 1 there is shown a high level system drawing of an illustrative auxiliary power system 100. In the illustrative embodiment, the auxiliary power system 100 includes a housing shown in FIG. 6, an auxiliary engine 102, a pump 104, a suction line 106, a pressure line 108 and an offload control module 110. The housing is fixedly coupled to a truck frame as shown in FIG. 2.

The auxiliary engine 102 is also operatively coupled to a truck fuel tank 112. By way of example and not of limitation, the illustrative engine is a Kubota Diesel Engine Super 05 Series Model V1505 is used. The Model 1505 is a 1.5 liter, 4-cylinder engine which weighs approximately 250 pounds. The illustrative auxiliary engine has approximately 1/10^{th} the horsepower of the main truck engine.

The pump 104 is also operatively coupled to the auxiliary engine 102 so that the pump 104 is powered by the auxiliary engine 102. The suction line 106 is also operatively coupled to the pump 104. Additionally, the suction line 106 is coupled to a truck hydraulic tank 114. The truck hydraulic tank 114 houses a hydraulic fluid material such as propane.

The pressure line 108 is also operatively coupled to the pump 104. The offload control module 110 is electrically coupled to the auxiliary engine 102 and the offload control module 110 is also configured to control the pump 104.

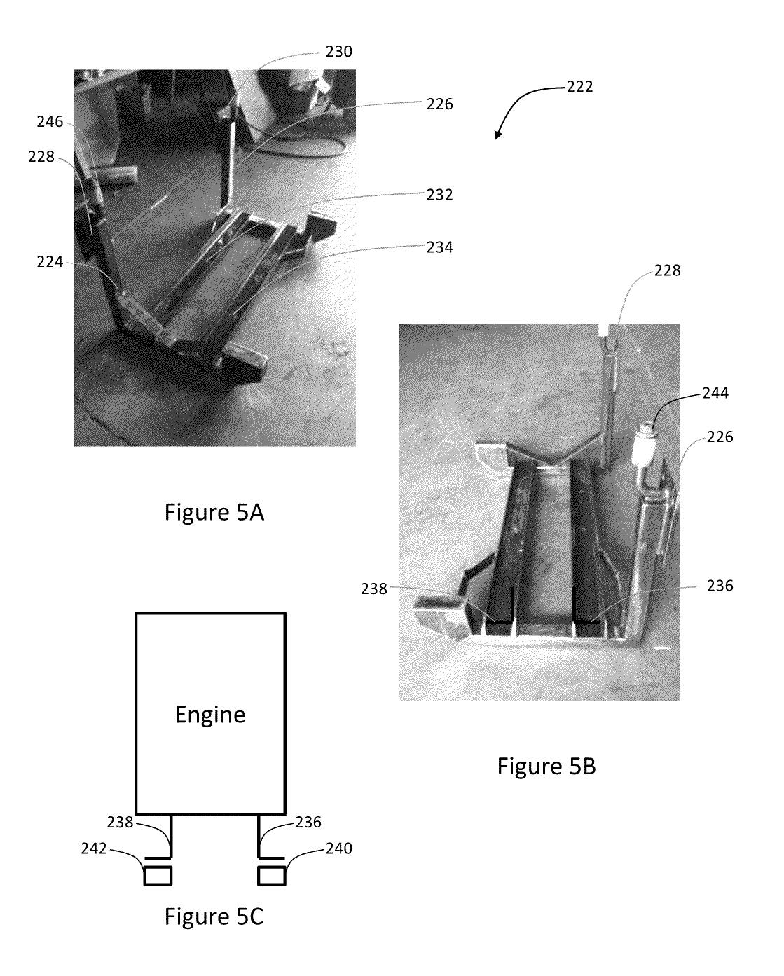

As presented in further detail at FIGS. 5A-5C, the housing includes an engine mount to which the auxiliary engine 102 is fixedly coupled.

The pressure line 108 transfers the material from the truck hydraulic tank 114 to a second hydraulic tank 116. Also, the auxiliary power system 100 includes an offload pump 118 that is operatively coupled to the pressure line 108 and regulates flow of the hydraulic material transferred to the second hydraulic tank 116.

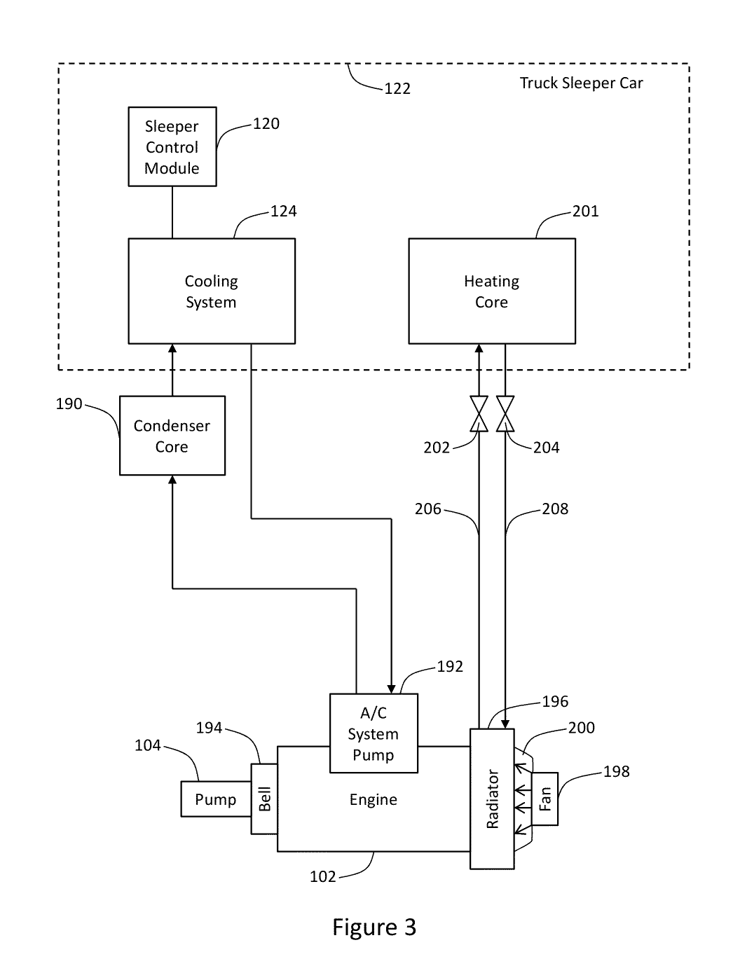

Additionally, the illustrative auxiliary power system 100 includes a sleeper control module 120 that is electrically coupled to the auxiliary engine 102. The illustrative sleeper control module 120 controls the temperature corresponding to a truck sleeper cab 122. The illustrative cooling system 124 disposed in the truck sleeper cab 122 includes an air conditioning system pump (shown in FIG. 3) and is operatively coupled to the auxiliary engine 102, in which the cooling system 124 is controlled by the sleeper control module 120.

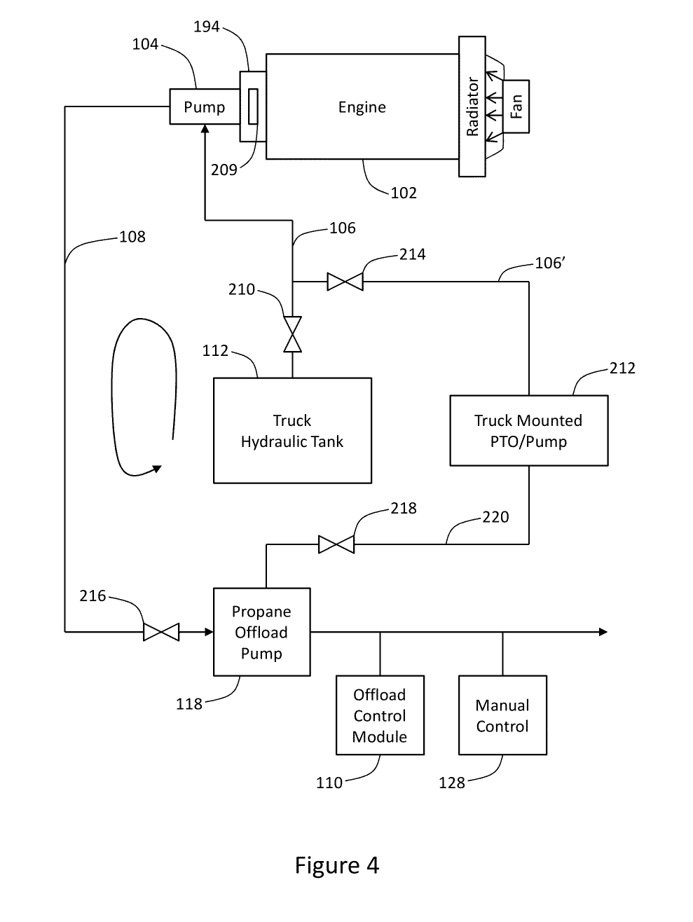

As shown in FIG. 3-4, the auxiliary engine 102 may be operatively coupled to a fan and a radiator. The housing (shown in FIG. 6) includes vents that enable air to flow to the fan and the radiator.

In the illustrative embodiment there are two fuel lines: a first fuel line 130 that conveys diesel fuel from the diesel truck fuel tank 112 to the diesel auxiliary engine 102; and a second fuel line 132 that conveys remaining diesel fuel from the auxiliary diesel engine 102 to the main diesel truck fuel tank 112. A fuel injection pump (not shown) corresponding to the auxiliary engine 102 is operatively coupled to the fuel lines.

Additionally, the illustrative embodiment can perform heating and cooling operations for the truck cabin and truck sleeper cab. The first heating line 134 is configured to interface with a heating system 135 and transmit heat generated by the auxiliary engine 102. The second heating line 136 is a return line that connects the heating system 135 to the auxiliary engine 102.

In the illustrative embodiment, the heating system 135 is operatively coupled to existing heating controls in the truck cabin. Thus, the heating system is controlled by the existing controls on the dashboard in the truck cabin.

In one embodiment, the sleeper control module 120 can be housed in the truck sleeper berth and can be used to control the heating system 135 and the cooling system 124.

With respect to the cooling system 124, a first cooling line 138 transmits coolant, e.g. Freon, from the auxiliary engine 102 to the cooling system 124. A second cooling line 140 operates as a return line and returns coolant from the cooling system 124 to the auxiliary engine 102.

Referring to FIG. 2 there is shown a system diagram that includes various control modules interfacing with the electrical systems corresponding to the auxiliary power systems of FIG. 1.

The illustrative exhaust 152 sits on the “inside” of the housing shown in FIG. 6 and includes a muffler 154. By way of example and not of limitation, the exhaust 152 has a 1.5 inch pipe.

The auxiliary engine 102 sits inside the frame, is mounted with a small alternator 156, and is electrically coupled to truck engine batteries 160 and 162. A starter 158 is also electrically coupled to alternator 156 and to engine batteries 160 and 162. The engine 102 having the alternator 156 and starter 158 that are electrically coupled to truck engine batteries 160 and 162 can also be used as a back-up engine that can easily start when the much larger main truck engine (not shown) is unable to start. The auxiliary engine 102 thus creates a redundant system that can be started from inside the truck sleeper or truck cabin.

In the illustrative embodiment, the sleeper control module 120 is disposed inside the truck sleeper. The sleeper control module 120 includes a variety of electrical controls including an auxiliary engine start control 164, an on/off air conditioning control 166, and a fan control 168.

By way of example and not of limitation, the air conditioning control 166 is a push button that starts the air conditioning pumps such as a condenser core (not shown) that are controlled automatically. The illustrative fan control 168 includes three fan setting such as high fan speed, medium fan speed, and low fan speed.

The illustrative offload control module 110 and manual control module 128 are presented in further detail in FIG. 2. The illustrative offload control module 110 and manual control 128 are disposed on the exterior of the truck and may be located behind the truck sleeper. The illustrative offload control module 110 and manual control module 128 are operated manually by the driver or operator and are housed in a weatherproof housing.

By way of example and not of limitation, the offload control module 110 includes a key ignition control 170, a high idle control 172, a temperature control module 174, a tachometer 176, and a voltage guage 178. The temperature control module 174, tachometer 176, and voltage gauge 178 may be embodied in a guage pack that is electrically coupled to automatically shut down the auxiliary engine 102 due to sudden loss of oil pressure or coolant temperature getting to high. The tachometer 176 monitors the RPM of the engine. The voltage guage 178 monitors the voltage for the main engine truck system. The temperature control module 174 monitors the temperature of the coolant corresponding to the auxiliary engine radiator.

The key ignition control 170 is configured to receive a key that triggers the auxiliary engine 102 to run at a low idle. The high idle control 172 may be a button that when pushed allows the engine 102 to operate at a much higher idle, which results in the pump 104 pumping more fluid.

The illustrative manual control 128 is adjacent to the offload control module 110. The manual control 128 includes three positions; forward position 180, neutral position 182, and pump position 184. The manual control 128 is used to control the offload process.

The forward position 180 is used to relieve pressure in a hydraulic line so that if one of the two hydraulic hoses is under pressure and other pressure line is not under pressure, the pressure can be released from the pressurized line. The neutral position 182 is the start position for the offload control process of the bulk fluid. The pump position 184 is engaged when the operator is ready to start transferring bulk fluid, such as propane, from the truck hydraulic tank 114 to the other hydraulic tank 116.

In operation, the operator begins by connecting the bulk fluid hoses 106 and 108. The operator then puts the key into the key ignition control 170 of the offload control module 110 and the auxiliary engine 102 starts operating at a low idle, as described above. The operator then switches manual control 128 from the neutral position 182 to the pump position 184, which engages the pump 104 to start offloading the propane. The operator can then increase the pump flow by engaging the high idle button to initiate a high idle pump operation. When the pumping operation is completed, the pump 104 returns to a low idle.

Additionally, an illustrative safety system 186 is also shown in FIG. 2. The safety system 186 is used to detect pressure changes caused by a burst in one of the hoses. When a change in pressure is detected, a safety switch 188 then proceeds to initiate an automatic shutoff of the auxiliary engine 102.

Referring to FIG. 3 there is shown an illustrative HVAC system corresponding to the auxiliary power system of FIG. 1. The illustrative sleeper control module 120 controls the temperature corresponding to a truck sleeper cab 122. The illustrative cooling system 124 disposed in the truck sleeper cab 122 includes a condenser core 190 and an air conditioning system pump 192 that are operatively coupled to the auxiliary engine 102. The illustrative cooling system 124 is controlled by the sleeper control module 120. The illustrative air conditioning system pump 192 sits on the auxiliary engine 102 and is operatively coupled to the cooling system 124.

A bell housing 194 is shown being operatively coupled to the auxiliary diesel engine 102. Additionally, on the opposite side of the bell housing there is shown a radiator 196 that is operatively coupled to a fan 198 that forces air through a shroud 200, which then distributes the air to the surface of the radiator. In the illustrative embodiment, the fan 198 is smaller than the radiator 196 and so the shroud 200 is employed to distribute air flow over the radiator 196.

In the illustrative embodiment shown in FIG. 3, the cooling system 124 is separated from the heating system. The illustrative cooling system 124 is a free standing system that includes the condenser core 190 and air conditioning system pump that sits on the auxiliary engine 102. The cooling system 124 includes an evaporator or fan and cooling lines. In the illustrative embodiment, the condenser core 190 is adjacent to the truck sleeper and it is used to dissipate heat from the coolant.

An illustrative heating system is also shown that includes heating core 201 and a first heating valve 202 associated with heating line 206, and second heating valve 204 associated with heating line 208. Each of the heating lines includes a coolant corresponding to radiator 196. By way of example and not of limitation, the heating core 201 is the existing truck sleeper heater core and the heating lines 206 and 208 tap into the existing truck heating system (not shown). Thus, the heating system corresponding to the main truck engine can be isolated. Also, the heating system associated with the auxiliary engine 102 can also be isolated from the main truck engine heating system. Additionally, the heating systems from the main truck engine and the auxiliary engine may be combined.

Referring to FIG. 4 there is shown an illustrative hydraulic system that is used to replace an existing power takeoff system. The illustrative hydraulic pump 104 attaches directly to the bell housing 194 that includes a drive coupler 209 housed within the bell housing 194. By way of example and not of limitation, the pump 104 may be a Parker hydraulic pump.

The suction line 106 is operatively coupled to the truck hydraulic tank 112. A first suction valve 210 is disposed between the truck hydraulic tank 112 and the pump 104 and operates as described above.

Additionally, there is shown a truck mounted PTO pump 212 that is also operatively coupled to the suction line 106′. The suction line 106′ includes a valve 214 disposed between the truck mounted PTO pump 212 and the truck hydraulic tank 112.

A pressure line 108 is shown that conveys the fluid to the offload pump 118 via valve 216. Another valve 218 is used to control the flow along PTO line 220. The truck-mounted PTO pump 212 represents a present day system used to pump the bulk fluid, e.g. propane, in the truck hydraulic tank 112.

The auxiliary engine 102 replaces the truck-mounted PTO pump 212. The valves 214 and 218 are used to separate the PTO pump 212 from the auxiliary engine pump 104. The illustrative valves described above are mechanical valves.

Referring to FIGS. 5A and 5B there is shown two isometric side views of an engine mount assembly 222 that is configured to interface with the auxiliary engine 102. FIG. 5A presents a pump end of the auxiliary engine 102, in which the pump 104 is proximate to frame mount 224. The radiator end of the auxiliary engine 102 is proximate to frame mount 226.

The assembly 222 is bolted to the truck and interfaces with the truck hydraulic system, heating system, and cooling system as described above. Two four-bolt flanges 228 and 230 are welded to the upright frame mounts 224 and 226, respectively. The two four-bolt flanges are then welded and mounted to truck frame.

The two frame mounts 224 and 226 and two pieces of channel iron 232 and 234 form a cradle that receives engine 102. By way of example, three-inch channel iron is used. The auxiliary engine 102 sits in the cradle.

In the illustrative embodiment, the auxiliary engine 102 includes L-bracket motor mounts 236 and 238 that are joined to the auxiliary engine, as shown in FIG. 5C. The L-bracket motor mounts 236 and 238 fit into the U-channel corresponding to the channel iron 232 and 234 that define the cradle. More particularly, the L-brackets 236 and 238 fit into the channels defined by channel iron 232 and 234 as shown in FIG. 5B.

The illustrative L-brackets 236 and 238 are configured to interface with rubber mounts 240 and 242, respectively. The rubber mounts perform as vibration dampeners. Additionally rubber absorption dampers 244 and 246 are used to interface with the cover described in FIG. 6.

Referring to FIG. 6, there is shown an isometric view of an illustrative vented housing for the auxiliary engine 102. The housing 250 includes a vented side 252 that is louvered to permit air to flow to the radiator that is adjacent to the vented side 252, much like a radiator car engine is adjacent to the grill. A cover 254 is configured to be lifted and allows access to the engine 102 and its components. Handles (not shown) can be used to facilitate removal of the cover.

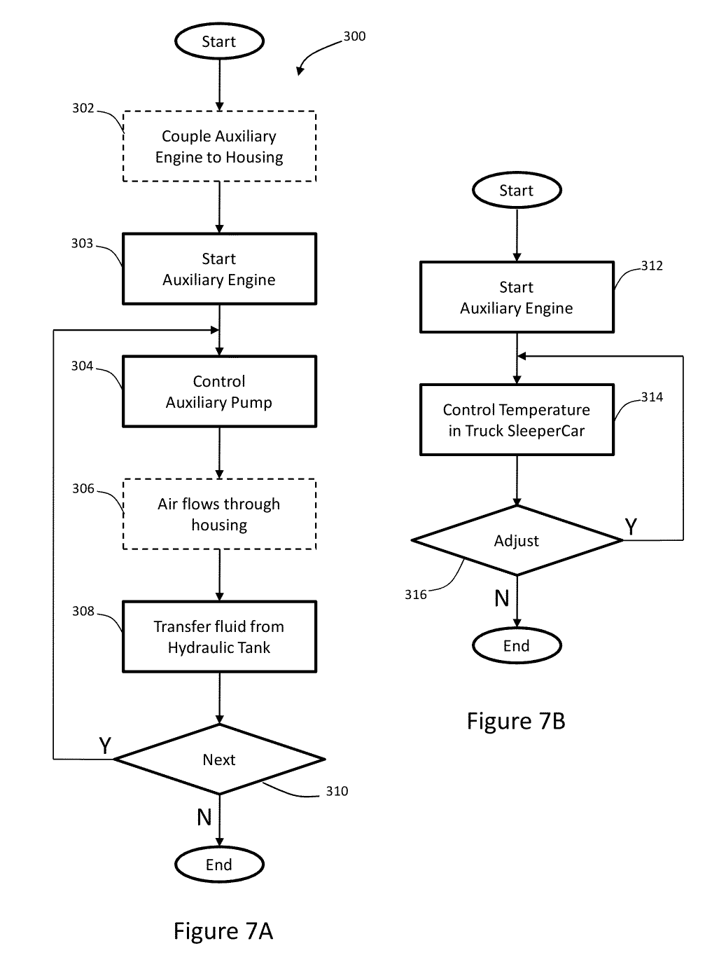

In FIG. 7A there is shown an illustrative method for configuring the auxiliary power system 100 to bypass the truck engine in order to transfer fluid from the truck hydraulic tank.

At block 302, the method may include coupling the auxiliary engine 102 to an engine mount that corresponds to the housing. This step may not be necessary if the housing is molded to receive the auxiliary engine.

At block 303, the auxiliary engine 102 is engaged via a control module such as offload control module 110 or manual control module 128.

At block 304, the method includes controlling a pump that is operatively coupled to an auxiliary engine 102 with an offload control module 110 and the pump 104 is powered by the auxiliary engine 102, as described above. The auxiliary engine 102 is also coupled to a truck fuel tank 112. The auxiliary engine 102 also includes a fan 198 and a radiator 196 as described above in FIGS. 3 and 4.

At block 306, the illustrative embodiment may include a vented housing 250 that allows air to flow through the vented housing that is fixedly coupled to the truck, as described in FIG. 6. The vented housing is configured to receive or house the auxiliary engine 102, fan 198, and radiator 196. Alternatively, the vented housing, fan, and radiator may not be required to effectively power the pump 104, if the illustrative auxiliary engine 102 can be adequately cooled. In yet another illustrative embodiment, the auxiliary engine may include an electrical engine and an electrical battery that may also not require a fan and a radiator for cooling.

At block 308, the fluid housed by the truck hydraulic tank 114 is transferred by the pump 104 from the suction line 106 to the pressure line 108. As described above, the suction line 106 is coupled to the truck hydraulic tank 114 and the pump 104. The pressure line 108 is used to transfer the fluid from the truck hydraulic tank to the second hydraulic tank 116. As described above, the pressure line 108 is coupled to the pump 104 and the propane offload pump 118.

The propane offload pump 118 then further transfers the fluid to the hydraulic tank 116 via the control line 126. In the illustrative embodiment, the flow of the fluid material transferred to the other hydraulic tank 116 may be further regulated by the offload pump 118. In the illustrative embodiments presented above, the offload control module 110 may also be configured to control valves disposed between the truck hydraulic tank and an offload pump.

The method then proceeds to decision diamond 310 where a determination is made to continue controlling the fluid transfer. If the decision is to continue regulating the fluid transfer, the method proceeds to block 304. If the decision is to stop the fluid transfer, the method ends. As described above, the fluid transfer may be stopped because a safety switch has been tripped. The fluid transfer may also be stopped manually by an operator. In the illustrative embodiment, the method enables the auxiliary engine 102 to transfer the material housed by the truck hydraulic tank 114 without engaging the truck engine (not shown).

In FIG. 7B, there is also shown an illustrative method where the auxiliary power system 100 can also be used to bypass the truck engine to control the temperature in a truck sleeper cab.

The method is initiated at block 312, by starting the auxiliary engine 102.

The method then continued to block 314 where the temperature of the truck sleeper cab is controlled by at least one sleeper control module 120. In the illustrative embodiment, the sleeper control module 120 is electrically coupled to the auxiliary engine 102. By way of example and not of limitation, the illustrative cooling system 124 includes an air conditioning system pump operatively coupled to the auxiliary engine is controlled by the sleeper control module 120.

At block 314, the sleeper control module 120 may include a fan or thermostat as described above in FIG. 2 that is used to further control the temperature in the truck sleeper cab 122.

At decision diamond 316, the method proceeds to determine whether to adjust the temperature control setting. The temperature control setting may be adjusted by a separate control process that is operatively coupled to one or more sensors, e.g. a temperature sensor. Additionally, the temperature control settings may also be adjusted manually by the operator.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. An auxiliary power system configured to be fixedly coupled and operationally coupled to a truck, the auxiliary power system comprising:
a housing configured to be fixedly coupled to a truck frame;
an auxiliary engine configured to be operatively coupled to a truck fuel tank;
a pump operatively coupled to the auxiliary engine, wherein the pump is configured to be powered by the auxiliary engine;
a suction line operatively coupled to the pump, wherein the suction line is configured to be coupled to the a truck hydraulic tank and receive a material housed by the truck hydraulic tank;
a pressure line operatively coupled to the pump; and
an offload control module electrically coupled to the auxiliary engine, wherein the offload control module is configured to control the pump.

2. The auxiliary power system of claim 1 wherein the housing includes an engine mount and the auxiliary engine is fixedly coupled to the engine mount.

3. The auxiliary power system of claim 1 wherein the pressure line is configured to transfer the material from the truck hydraulic tank to a second hydraulic tank.

4. The auxiliary power system of claim 3 further comprising an offload pump that is operatively coupled to the pressure line and configured to regulate flow of the hydraulic material transferred to the second hydraulic tank.

5. The auxiliary power system of claim 1 further comprising a sleeper control module configured to be electrically coupled to the auxiliary engine, wherein the sleeper control module is configured to control a temperature corresponding to a truck sleeper cab.

6. The auxiliary power system of claim 5 further comprising a cooling system that includes an air conditioning system pump operatively coupled to the auxiliary engine, wherein the cooling system is configured to be controlled by the sleeper control module.

7. The auxiliary power system of claim 1 further comprising a fan and a radiator operatively coupled to the auxiliary engine.

8. The auxiliary power system of claim 7 wherein the housing includes a plurality of vents configured to enable air to flow to the fan and the radiator.

9. An auxiliary power system configured to be fixedly coupled and operationally coupled to a truck, wherein the auxiliary power system is configured to bypass a truck engine that pumps material housed by a truck hydraulic tank, the auxiliary power system comprising:
an auxiliary engine configured to be operatively coupled to a truck fuel tank;
a fan and a radiator operatively coupled to the auxiliary engine;
a housing configured to be fixedly coupled to the truck, wherein the housing includes a plurality of vents configured to enable air to flow to the fan and the radiator;
a pump operatively coupled to the auxiliary engine, wherein the pump is configured to be powered by the auxiliary engine;
a suction line operatively coupled to the pump, wherein the suction line is configured to be coupled to with a truck hydraulic tank and receive a material housed by the truck hydraulic tank;
a pressure line operatively coupled to the pump, wherein the pressure line is configured to transfer the material from the truck hydraulic tank to a second hydraulic tank; and
an offload control module electrically coupled to the auxiliary engine, wherein the offload control module is configured to control the pump.

10. The auxiliary power system of claim 9 wherein the housing includes an engine mount and the auxiliary engine is fixedly coupled to the engine mount.

11. The auxiliary power system of claim 9 further comprising an offload pump that is operatively coupled to the pressure line and configured to regulate flow of the hydraulic material transferred to the second hydraulic tank.

12. The auxiliary power system of claim 9 further comprising a sleeper control module configured to be electrically coupled to the auxiliary engine, wherein the sleeper control module is configured to control a temperature corresponding to a truck sleeper cab.

13. The auxiliary power system of claim 12 further comprising a cooling system that includes an air conditioning system pump operatively coupled to the auxiliary engine, wherein the cooling system is configured to be controlled by the sleeper control module.

14. A method for configuring an auxiliary power system, the method comprising:
controlling a pump that is operatively coupled to an auxiliary engine with an offload control module, wherein the pump is configured to be powered by the auxiliary engine;
coupling the auxiliary engine to a truck fuel tank, wherein the auxiliary engine includes a fan and a radiator;
enabling air to flow through a housing fixedly coupled to the truck, wherein the housing is configured to the receive the auxiliary engine and includes a plurality of vents configured to enable air to flow to the fan and the radiator; and
transferring a material housed by the a truck hydraulic tank via a suction line operatively coupled to the pump to a pressure line that is also operatively coupled to the pump, wherein the suction line is configured to be coupled to a truck hydraulic tank and the pressure line is configured to transfer the material from the truck hydraulic tank to a second hydraulic tank.

15. The method of claim 14 further comprising coupling the auxiliary engine to an engine mount corresponding to the housing.

16. The method of claim 14 further comprising regulating flow of the hydraulic material transferred to the second hydraulic tank with an offload pump that is coupled to the pressure line.

17. The method of claim 14 further comprising controlling a temperature corresponding to a truck sleeper cab with a sleeper control module that is electrically coupled to the auxiliary engine.

18. The method of claim 17 further comprising controlling a cooling system that includes an air conditioning system pump operatively coupled to the auxiliary engine with the sleeper control module.

19. The method of claim 14 further comprising enabling the offload control module to control a plurality of valves disposed between the truck hydraulic tank and an offload pump.

20. The method of claim 14 further comprising enabling the auxiliary engine to transfer the material housed by the truck hydraulic tank without engaging a truck engine.
